(19) United States
(12) Patent Application Publication
(10) Pub. No.: US 2024/0195288 A1
(43) Pub. Date: Jun. 13, 2024

(54) METHOD OF CONTROLLING A POWER CONVERTER, CONVERTER ARRANGEMENT AND COMPUTER PROGRAM PRODUCT

(71) Applicant: HITACHI ENERGY Ltd, Zürich (CH)

(72) Inventors: Alessandro ROSINI, Lavagna, GE (IT); Andrew TUCKEY, Livingstone, NT (AU); Andrea BONFIGLIO, Rapallo, GE (IT)

(21) Appl. No.: 18/556,242

(22) PCT Filed: Apr. 20, 2021
(86) PCT No.: PCT/IT2021/000020

§ 371 Date: Oct. 19, 2023

(51) Int. Cl. H02M 1/32; H02M 3/155

(52) U.S. Cl. CPC H02M 1/32; H02M 3/155

(57) ABSTRACT

A frequency control error, active power target, phase angle target, voltage control error, reactive power target, and output voltage target may be determined. A power converter may be controlled based on the output voltage target and phase angle target. This may comprise determining the active power target independent of the frequency control error when detecting a fault signal and dependent on the frequency control error otherwise, determining the phase angle target independent of the active power target when detecting a fault signal and dependent on the active power target otherwise, determining the reactive power target independent of the voltage control error when detecting a fault signal and dependent on the voltage control error otherwise, and/or determining the output voltage target independent of the reactive power target when detecting a fault signal and dependent on the reactive power target otherwise.

### TECHNICAL FIELD

The present disclosure relates to a method of controlling a power converter, a converter arrangement and a computer program product.

### BACKGROUND ART

The power converter converts electric power from a first side of the power converter to a second side of the power converter and in an example also from the second side to the first side. This ability for power to be converted from the first side to the second side and the second side to the first side is referred to as being bidirectional. The first side of the power converter is coupled e.g. to a renewable energy source or a battery or other energy storage device. The second side is coupled e.g. to a grid.

Typically the power converter is a single- or multi-phase voltage-source converter (abbreviated VSC). A VSC can be either current controlled (abbreviated CC-VSC for Current Controlled VSC) where the ac current is the primary controlled variable or voltage controlled (abbreviated VC-VSC for Voltage Controlled VSC) where the ac voltage is the primary controlled variable. Hybrid controlled VSCs also exist where the primary controlled variable is a combination of the ac current and the ac voltage.

A Synchronous Generator (abbreviated SG) is the predominant power producing device in power systems. It comprises two parts: The prime mover and the synchronous machine. The prime mover is an energy conversion device which converts energy in some form such as steam or natural gas into rotational energy. The synchronous machine converts the rotational energy into ac electrical energy.

Power grids are becoming more decentralized with more renewable energy sources (abbreviated RESs), e.g. solar photovoltaic arrangements, and storage systems being integrated into the grid. These RESs or storage systems use a power converter to provide an interface for power or energy transfer between the energy source or the storage system and the grid. As the percentage of renewables and non-synchronous machine interfaced energy sources increases, the percentage of generation provided from traditional synchronous generators is reduced, and this results in an overall reduction in grid strength and stiffness.

SGs may exhibit partial or full desynchronization during faults (faults in the grid, microgrid and/or connecting equipment), wherein partial desynchronization may result in a significant power required post fault in order to resynchronize the SG and return to the steady-state. Full desynchronization may result in a “pole slip” where the rotor of a SG slips 1 or multiple pole-pairs and reindexes at 1 or multiple 360 degree electrical from its original index position. This may cause large currents to flow in both the generator and power system and may cause the generator to trip or protection devices in the power system to trip.

One use of a VC-VSC is to create an ac electrical network or grid. The energy can come from an energy storage system or device, such as a battery, flywheel or super capacitor, or an energy producing device such as a generator or a photovoltaic arrangement, or even another grid. Bidirectional VC-VSCs can be used as a load (consuming energy from the grid) or as a generator (generating energy to a grid). This ability to both produce and consume energy means the VSC can create a grid and run as the only grid-forming device on the grid, i.e. stand-alone, or can be used to stabilize the frequency or voltage of a grid formed by other devices.

In an example, VC-VSCs are implemented with control systems to enable them to appear like or mimic a synchronous generator, e.g. to enable stand-alone and parallel operation of VSCs, operation in parallel with other sources such as a synchronous generator, and operation in parallel with the grid. A VSC which is operated this way can be referred to as a Virtual Synchronous Generator (abbreviated VSG).

Article “Practical application of a complete virtual synchronous generator control method for microgrid and grid-edge application”, A. Tuckey and S. Round, 19th IEEE Workshop on Control and Modelling of Power Electronics, Italy, Jun. 25-28, 2018 describes a VSG.

VSGs can experience partial and full desynchronization, just like SGs. In an example, during faults, the response can be improved by changing the characteristics of the functionalities adaptively in real time, i.e. adjust the parameters such as an inertia constant H, gains Kp and Ki and maximum and minimum limits of the frequency governor functionality.

Document EP3376627 A1 refers to a method and control system for controlling a power converter.

However, although adjusting the inertia constant and speed governor gains and limits improves the response, it is not sufficient to create a fully-functioning practical VSG with superior fault response during and post faults. Other control variations are required.

### DISCLOSURE OF INVENTION

The object of the invention can be to provide an improved energy transfer and power converter control.

This object is solved by a method of controlling a power converter according to the features of claim 1.

Further embodiments of the invention relate to a converter arrangement and a computer program product for controlling a power converter.

According to an embodiment, a method of controlling a power converter comprises:
determining a frequency control error in dependence on at least a setpoint frequency and an actual frequency,
determining an active power target,
determining a phase angle target in dependence on at least the active power target,
determining a voltage control error in dependence on at least a setpoint voltage and an actual voltage,
determining a reactive power target,
determining an output voltage target in dependence on at least the reactive power target, and
controlling the power converter based on the output voltage target and the phase angle target.

Moreover, the method comprises at least one of determining the active power target independent of the frequency control error in case a fault signal indicating a fault is detected and determining the active power target in dependence on at least the frequency control error otherwise,
determining the phase angle target independent of the active power target in case a fault signal indicating a fault is detected and determining the phase angle target in dependence on at least the active power target otherwise,
determining the reactive power target independent of the voltage control error in case a fault signal indicating a fault is detected and determining the reactive power target in dependence on at least the voltage control error otherwise, and
determining the output voltage target independent of the reactive power target in case a fault signal indicating a fault is detected and determining the output voltage target in dependence on at least the reactive power target otherwise.

Advantageously, in case a fault signal indicating a fault is detected, at least one the active power target, the phase angle target, the reactive power target and the output voltage target is no longer determined as in the case no fault signal indicating a fault is detected. In case a fault signal indicating a fault is detected, at least one of these values is e.g. kept constant or determined in another manner in order to improve energy transfer and control of the power converter.

According to an embodiment, the method comprises determining an initialization value of at least one of an actual active power and an actual reactive power of the power converter when the fault signal indicating a fault is detected.

According to an embodiment, the method comprises continuously storing data in a memory in predetermined periods. The data include at least one of the actual active power and the actual reactive power. Determining the initialization value includes selecting the initialization value out of the data stored in the memory.

According to an embodiment, the method comprises determining that the fault is no longer detected, and determining the active power target using the initialization value of the actual active power and/or determining the reactive power target using the initialization value of the actual reactive power.

According to an embodiment, the method comprises waiting for a predetermined time after detecting that the fault is no longer detected before determining the active power target using the initialization value of the actual active power and/or determining the reactive power target using the initialization value of the actual reactive power.

According to an embodiment, the method is configured to mimic a synchronous generator.

According to an embodiment, in case no fault signal indicating a fault is detected, determining the phase angle target in dependence on at least the active power target includes: determining an active power error in dependence on at least the active power target and an actual active power, and determining the phase angle target in dependence on at least the active power error.

According to an embodiment, in case the fault signal indicating a fault is detected, determining the phase angle target independent of the active power target includes making or keeping constant a target frequency.

According to an embodiment, in case no fault signal indicating a fault is detected, determining the output voltage target in dependence on at least the reactive power target includes: determining a reactive power error in dependence on at least the reactive power target and an actual reactive power and determining the output voltage target in dependence on at least the reactive power error.

According to an embodiment, in case a fault signal indicating a fault is detected, determining the output voltage target independent of the reactive power target includes keeping the output voltage target constant.

In the context of the disclosure below the term functionality refers to a set or group of one or more functions based on executable program code, like for example program code lines, functional blocks, function subroutines and/or procedures. The term functionality is used to ease the understanding of the method. In a possible realization of the method different functionalities may be combined into one functionality.

According to a further embodiment, determining the frequency control error and determining the active power target is performed by a frequency governor functionality. Determining an internal frequency and a phase angle target is performed by an inertia functionality. Determining the voltage control error and determining the reactive power target is performed by an automatic voltage regulator functionality. Determining the output voltage target is performed by a rotor flux functionality. Controlling the power converter based on the output voltage target and the phase angle target is performed by a transformation functionality. Optionally, these functionalities are combined. The functionalities can be written in separate blocks of program code or in combined blocks of program code or in one block of program code.

In an example, when operating in the steady-state the frequency setpoint and the voltage setpoint will be constant values. Also the frequency control error will be zero and the active power target will equal the actual active power, the voltage control error will be zero and the reactive power target will equal the actual reactive power.

In an example, during a fault the actual active power and the actual reactive power may vary from the steady-state values. The actual voltage and the actual frequency may also vary from the steady-state values. These variations in the actual active power, the actual reactive power, the actual voltage and the actual frequency contribute to the desynchronization of the VSG during faults.

Moreover, in a further embodiment, the method comprises e.g.: When the fault signal indicating a fault is detected suspending execution of at least one functionality of the frequency governor functionality, the automatic voltage regulator functionality, the rotor flux functionality and the inertia functionality. For the frequency governor functionality, the automatic voltage regulator functionality, or the rotor flux functionality suspended means that the algorithm or function execution is suspended and the output is one of being fixed, being locked, remaining constant and being frozen. For the inertia functionality suspended means that the algorithm or function execution is suspended and the frequency is one of being fixed, being locked, remaining constant and being frozen and the angle continues to progress.

In a further embodiment, the constant output can be the value taken at the time when the fault occurred or can be some other value.

According to a further embodiment, advantageously at least one functionality of the frequency governor functionality, the automatic voltage regulator functionality, the inertia frequency functionality and the rotor flux functionality is suspended and the respective output is held constant until after the fault signal indicates an absence of a fault. Thus, an output value of this functionality which is an input value for the downstream functionality or transformation is constant. Thus, the downstream functionality or transformation can operate with high reliability and/or predictability also in case of a fault.

According to a further embodiment, only the execution of one of the functionalities is suspended. The other functionalities operate independently of the value of the fault signal.

According to a further embodiment, the execution of two of the functionalities is suspended. The other functionalities operate independently of the value of the fault signal.

According to a further embodiment, the execution of three of the functionalities is suspended. The other functionality operates independently of the value of the fault signal.

According to a further embodiment, the execution of all four of the functionalities is suspended.

In a further embodiment, the method is performed on-line, in particular when connected to the grid, and/or is performed in real-time.

According to an embodiment, a converter arrangement comprises a control arrangement and a power converter that is realized as a voltage-controlled voltage source converter. The control arrangement is configured to execute the method described in this disclosure. In an example, the power converter is configured to be connected to a grid and to an energy source/load arrangement.

According to an embodiment, a computer program product comprises instructions to cause the control arrangement to execute the method of controlling the power converter.

The method of controlling the power converter and the computer program product described above are for example suitable for the converter arrangement. Features and advantages described in connection with the converter arrangement and the computer program product can therefore be used for the method and vice versa.

In an example, a fault is an unintended or accidental short circuit or partial short circuit in the grid, the equipment connecting the converter to the grid, e.g. a coupling line or circuit breaker or transformer, or in the power converter itself. In 3-phase ac systems there are e.g. eight distinct types of short circuits, which are (1) 3-phase low impedance short circuits, (2) phase-to-phase low impedance short circuits, (3) phase-to-ground low impedance short circuits, (4) phase-to-phase-to-ground low impedance short circuits, (5) 3-phase high impedance short circuits, (6) phase-to-phase high impedance short circuits, (7) phase-to-ground high impedance short circuits, (8) phase-to-phase-to-ground high impedance short circuits. In 1-phase ac systems there are e.g. two distinct types of short circuits, which are (1) phase-to-ground low impedance short circuits, (2) phase-to-ground high impedance short circuits. The neutral is connected to the ground in some circumstances, either directly or via an impedance, so a to-ground fault is synonymous with a to-neutral fault. Many phenomena can cause faults. Examples are when cables of differing phases accidently touch each other; when animals create a conductive path between phases or a phase or multiple phases and ground, or between a phase or multiple phases and neutral; when insulators break down, when fires in transformers or circuit breakers or other equipment; lightning strikes create arcs that cause faults; and many others.

In an example, overloads, which are loads above the rating of the converter, usually cause excessive converter current. Slight overloads do not cause the output voltage of the converter to be reduced excessively whereas severe overloads do. A fault, particularly a low impedance fault, has a similar effect on a converter as a severe overload, that is, excessive converter current and reduced output voltage. In one example a method of detecting a fault can be to determine if the converter current is excessive and the converter output voltage is reduced. In another example a circuit breaker or fault relay can be used to detect a fault. In a further example a device upstream can be used to detect a fault. When a fault is detected using one of the example methods or another method the status of a fault variable or fault signal can be changed. Thus, the fault signal is configured to indicate a fault or to indicate an absence of a fault.

In an example, the words “determining a parameter in dependence on another parameter” have the meaning that the control arrangement includes e.g. at least one of a control loop, a look-up table, a fuzzy logic, a model and an observer or another item realized in hardware, in software or in a hardware/software combination which performs the process of determining. The words have the meaning that the parameter can optionally also depend on a further parameter.

In an example, the actual frequency, the actual voltage, the actual active power and the actual reactive power are values of the power converter.

In an example, the actual frequency, the actual voltage, the actual active power and the actual reactive power are measured or detected e.g. internal in the power converter or at terminals of the power converter or elsewhere. For example, one of more than one of these values are measured or detected at terminals of a second side of the power converter. The second side is e.g. connected to a grid.

In an example, the method of controlling a power converter and the control arrangement is configured for improved power converter response during grid disturbances. The control arrangement can be named control system.

The present disclosure comprises several aspects of a converter arrangement and a method of controlling a power converter. Every feature described with respect to one of the aspects is also disclosed herein with respect to the other aspect, even if the respective feature is not explicitly mentioned in the context of the specific aspect.

### BRIEF DESCRIPTION OF THE DRAWINGS

The accompanying figures are included to provide a further understanding. In the figures, elements of the same structure and/or functionality may be referenced by the same reference signs. It is to be understood that the embodiments shown in the figures are illustrative representations and are not necessarily drawn to scale.

FIGS. 1 and 2 are schematics of a converter arrangement according to different embodiments, and

FIGS. 3A and 3B are schematics of methods of controlling a power converter according to different embodiments.

### BEST MODE FOR CARRYING OUT THE INVENTION

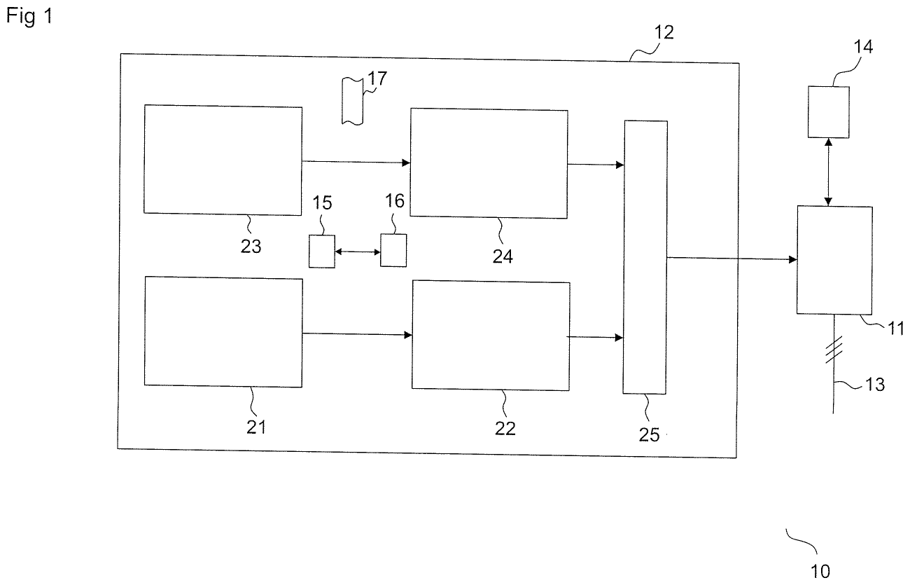

FIG. 1 is a schematics of a converter arrangement 10 according to an embodiment. The converter arrangement 10 comprises a control arrangement 12 and a power converter 11. The power converter 11 is realized as a voltage-controlled voltage source converter. The power converter 11 is configured to be connected to a grid 13 and an energy source/load arrangement 14. The source/load arrangement 14 is realized e.g. as one of a renewable energy source (abbreviated RESs) or energy storage device or another grid. The control arrangement 12 is configured to execute the method of controlling the power converter 11. The control arrangement 12 includes at least one of a computer, a microprocessor, a microcontroller and a field-programmable gate array, abbreviated FPGA. The control arrangement 12 comprises a memory 16 and optionally also an initialization value memory 15.

A computer program product 17 comprises instructions to cause the control arrangement 12 to execute the method of controlling the power converter 11.

In an example, the method includes at least the following executable functionalities: a frequency governor functionality 21, an inertia functionality 22, an automatic voltage regulator functionality 23 and a rotor flux functionality 24. The method mimics a synchronous generator. The frequency governor functionality 21, the inertia functionality 22, the automatic voltage regulator functionality 23 and the rotor flux functionality 24 mimic a synchronous generator. The method may have further functionalities such as e.g. a transformation functionality 25. The control arrangement 12 realizes the frequency governor functionality 21, the inertia functionality 22, the automatic voltage regulator functionality 23, the rotor flux functionality 24 and the transformation functionality 25, e.g. using the computer program product 17. A functionality can also be named module or block. Typically, a functionality is realized by software and/or hardware.

One aspect that both synchronous generators and VSGs exhibit is partial or full desynchronization during faults (faults in the grid or microgrid). Partial desynchronization results in a significant power required post fault (called resynchronization power or resynchronization torque) to resynchronize the synchronous generator or VSG and return to the steady-state. Utility regulators and standards e.g. limit this resynchronization power requiring 95% of pre-fault value within 100 ms. Full desynchronization results in a “pole slip” where the rotor of a synchronous generator slips 1 or multiple pole-pairs and reindexes at 1 or multiple 360 degree electrical from its original index position. This causes large currents to flow in both the generator and power system and may cause the generator to trip or protection devices in the power system to trip.

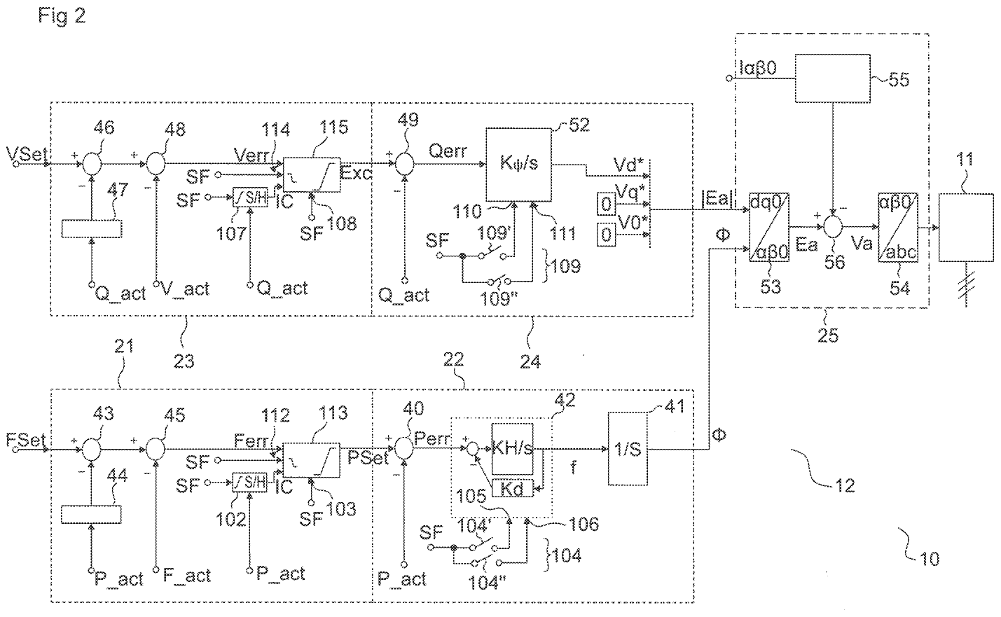

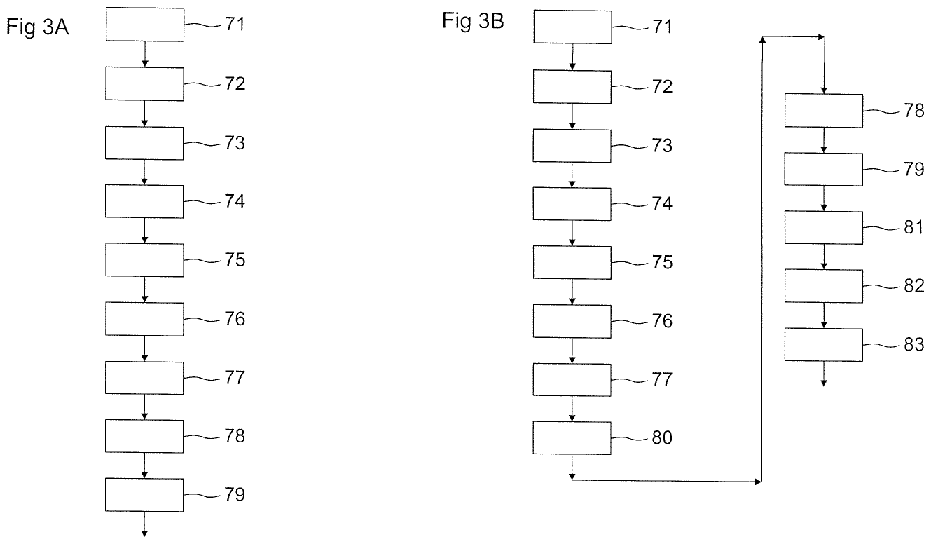

VSGs can experience partial and full desynchronization, just like synchronous generators. The power converter 11 operates as VSG. VSG operation during faults can be realized as described in FIGS. 2, 3A and 3B.

FIG. 2 is a schematic of a converter arrangement 10 according to an embodiment which is a further development of the embodiment shown in FIG. 1. In this disclosure the terms “flux” and “back emf” can be used interchangeably as these are similar in the VSG. The use of “suspend”, “freeze” and “lock” are interchanged but can refer to different things. The virtual inertia frequency f can be frozen or locked (e.g. the virtual inertia frequency f remains the same), but the action of the frequency governor functionality 21 is suspended or locked, meaning it remains inactive.

In rough terms, the method of controlling the power converter 11 is configured to lock or freeze or suspend the behavior of four of five control components, namely the SG Rotor Flux Model, the automatic voltage regulator (abbreviated AVR), the Inertia and the Speed/Frequency Governor. Thus, at least one of the frequency governor functionality 21, the inertia functionality 22, the automatic voltage regulator functionality 23 and the rotor flux functionality 24 are suspended, locked or frozen. The transformation functionality 25 (being the fifth control component) is not frozen or locked or suspended. Advantageously, the method reduces or avoids or stops partial a full desynchronization during faults for a VSG.

The method takes a snapshot of an actual active power P_act and an actual reactive power Q_act of the VSG at or slightly before the detection of a fault. The actual active power P act can be named output active power or active power. The actual reactive power Q_act can be named output reactive power or reactive power. At cessation of the fault, these values of the actual active power P_act and the actual reactive power Q_act (which have been stored and are no longer “actual” values, they are pre-fault values) will be used as initialization values. Also the values of the rotor flux and the virtual inertia frequency f are locked or frozen or close to locked or frozen and/or their parameters are adjusted at or slightly before the detection of a fault. Furthermore, the operation of the frequency governor functionality 21 and the AVR functionality 23 are stopped at the detection of a fault during which means their outputs are locked or frozen. Doing the above means that during the fault the flux/back emf and the virtual inertia remain in synchronism with the grid and the excitation and the governor power remain unchanged.

At or shortly after cessation of the fault the flux/back emf and the inertia are unfrozen and their parameters are restored to normal values (if they were changed). Also the frequency governor functionality 21 and the AVR functionality 23 are initialized with the snapshots of the active power P_act and the reactive power Q_act respectively and their operation is resumed. This results in a small resynchronization power and operation akin to the pre-fault steady-state in a short time. When the fault is cleared, the power converter 10 is configured to get immediately back to the steady-state. Thus, the initialization value of the actual reactive power Q_act is used to initialize the AVR functionality 23 and/or the initialization value of actual active power P_act is used to initialize the frequency governor functionality 21.

The operation of the control arrangement 12 is described below using FIGS. 3A and 3B.

FIG. 3A is a schematic of a method of controlling a power converter 11 according to an embodiment which is a further development of the embodiments shown in FIGS. 1 and 2.

The method of controlling a power converter 11 comprises:
determining a frequency control error Ferr in dependence on a setpoint frequency FSet and an actual frequency F_act of the power converter 11 (in a process 71),
determining an active power target PSet in dependence on the frequency control error Ferr by the frequency governor functionality 21 (in a process 72),
determining a phase angle target Φ in dependence on the active power target PSet by the inertia functionality 22 (in a process 73),
determining a voltage control error Verr in dependence on a setpoint voltage VSet and an actual voltage V_act provided by the power converter 11 (in a process 74),
determining a reactive power target Exc in dependence on the voltage control error Verr by an AVR functionality 23 (in a process 75),
determining an output voltage target Vd* in dependence on the reactive power target Exc by the rotor flux functionality 24 (in a process 76), and
controlling the power converter 11 based on the output voltage target Vd* and the phase angle target Φ (in a process 77).

The above mentioned processes 71 to 77 are performed during normal operation of the power converter 11 (in times without fault). During normal operation, the power converter 10 is at the steady-state. Thus, the voltage control error Verr and the frequency control error Ferr are zero or approximately zero prior to a fault.

Moreover, the method comprises:
changing a fault signal SF after detecting a fault such that the fault signal SF indicates a fault (in a process 78), and
suspending at least one functionality of the frequency governor functionality 21 and the inertia functionality 22, the automatic voltage regulator functionality 23 and the rotor flux functionality 24 such that the at least one suspended functionality provides a constant value at its output (in a process 79).

Some of the processes can take place in parallel; e.g. the processes 71 to 73 can be parallel to the processes 74 to 76. Process 79 follows process 78.

The occurrence of a fault is detected using a method or process. The fault signal SF indicates a fault (e.g. is set to a first logical value) e.g. in case a current limit of the power converter 11 is reached with the terminal voltage suppressed or another condition described above is detected. When the fault is detected the fault signal SF indicates a fault (e.g. obtains the first logical value). Thus, when the fault is detected, the fault signal SF indicating a fault can be detected. In other words, the fault signal SE is raised, giving it a “high” or “true” or “active” or “raised” value; the fault signal SF is used throughout the control scheme.

When the fault has ceased, known as being “cleared”, the fault signal SF indicates an absence of a fault (e.g. obtains a second logical value). In other words, the fault signal SF is lowered, giving it a “low” or “inactive” or “false” value. To improve the restoration of the pre-fault active power and the pre-fault reactive power, a short-predefined delay is e.g. introduced between the fault being cleared and the fault signal SF lowered in this method. The second logical value of the fault signal SF indicates an absence of a fault.

Thus, in the process 78, the fault is detected and the fault signal SF is raised.

In the process 79, while the fault signal SF indicates a fault (the fault signal SF is active), the action of the frequency governor functionality 21 is suspended causing the output of the frequency governor functionality 21, namely the active power target PSet, to have a constant value. Thus, the freezing prevents the integrator or other controller type to not wind up. The frequency governor functionality 21 includes a frequency controller 113 (also named FCtrl functionality or governor frequency controller). The frequency controller 113 is e.g. a P, PI or PID controller. P controller is the abbreviation for proportional controller, PI is the abbreviation for proportional-integral controller. PID is the abbreviation for proportional-integral-derivative controller. The frequency controller 113 includes a freeze control input 103 to which the fault signal SF is applied. In case the fault signal SF indicating a fault is applied to the frequency controller 113 (via the freeze control input 103), the frequency controller 113 provides the active power target PSet with a constant value, e.g. independent of the frequency control error Ferr. The constant value is the value of the active power target PSet before the change of the fault signal SF such that the fault signal SF indicates a fault.

In case the fault signal SF changes and now indicates an absence of a fault, the initialization value of the former actual active power P_act is applied to the frequency controller 113 from the memory 16 or the initialization value memory 15. In this way, the frequency governor functionality 21 can be initialized, in case the frequency governor functionality 21 has been suspended before.

Additionally, while the fault signal SF indicates a fault, the action of the AVR functionality 23 is suspended causing the output of the AVR functionality 23, namely the reactive power target Exc, to have a constant value. This prevents the integrator or other controller type to not wind up. The AVR functionality 23 includes a voltage controller 115 (also named VCtrl functionality). The voltage controller 115 is e.g. a P, PI or PID controller. The voltage controller 115 includes a freeze control input 108 to which the fault signal SF is applied. In case the fault signal SF indicating a fault is applied to the voltage controller 115 (via the freeze control input 108), the voltage controller 115 provides the reactive power target Exc with a constant value, e.g. independent of the voltage control error Verr. The constant value is the value of the reactive power target Exc before the change of the fault signal SF such that the fault signal SF indicates a fault.

In case the fault signal SF changes and now indicates an absence of a fault, the initialization value of the former actual reactive power Q_act is applied to the voltage controller 115 from the memory 16 or the initialization value memory 15. In this way, the AVR functionality 23 can be initialized, in case the AVR functionality 23 has been suspended before.

FIG. 3B is a schematic of a method of controlling a power converter according to an embodiments which is a further development of the embodiments shown in FIGS. 1, 2 and 3A. The method comprises storing a initialization value of at least one of the actual active power P_act and the actual reactive power Q_act of the power converter 11 in the initialization value memory 15 (in a process 80). Storing the value in the initialization value memory 15 is performed when the fault signal SF changes and after the change indicates a fault or after or before the fault signal SF has been set to indicate a fault. For example, the initialization value of the actual active power P_act is stored in the S/H memory 102. The initialization value of the actual reactive power Q_act is stored in the S/H memory 107.

In an example, the method comprises storing data of the power converter 11 in the memory 16 in predetermined periods. Storing a initialization value of at least one of the actual active power P_act and the actual reactive power Q_act of the power converter 11 in the initialization value memory 15 includes selecting the at least one value out of the data stored in the memory 16 and storing in the initialization value memory 15. The memory 16 is implemented e.g. as a circular buffer. The memory 16 is e.g. configured as a data logger. The memory 16 stores a history of at least one of the actual active power P_act and the actual reactive power Q_act data.

Alternatively, the initialization value of at least one of the actual active power P_act and the actual reactive power Q_act of the power converter 11 are taken directly from the memory 16. In this case, the initialization value memory 15 can be omitted.

Upon the change of the fault signal SF such that the fault signal SF indicates a fault, a snapshot of the actual active power P_act and/or the actual reactive power Q_act being delivered by the VSG is stored in the memory 16 and/or the initialization value memory 15. The actual active power P_act and/or the actual reactive power Q_act are values which are measured at the power converter 11. The initialization value memory 15 comprises e.g. a sample-and-hold memory 102 (abbreviated S/H memory) and a further S/H memory 107. This is indicated by a rising edge trigger of the S/H memories 102, 107. Thus, the actual active power P_act and/or the actual reactive power Q_act are stored in the initialization value memory 15, e.g. at the rising edge of the fault signal SF. The value or values stored may be at the instance of the fault signal SF or slightly earlier to ensure that a suitable steady-state value is stored. This is achieved e.g. by the circular buffer of the memory 16, described above.

The control arrangement 12 is implemented such that the frequency governor functionality 21, the inertia functionality 22, the AVR functionality 23 and the rotor flux functionality 24 are configured to mimic a synchronous generator.

In the following, processes of the control arrangement 12 before a fault are described: In case the fault signal SF indicates an absence of a fault, determining the phase angle target Φ in dependence on the active power target PSet by the inertia functionality 22 includes:
determining an active power error Perr in dependence on the active power target PSet and the actual active power P_act by the inertia functionality 22, and
determining the phase angle target @ in dependence on the active power error Perr by the inertia functionality 22.

The active power target PSet is provided at an output of the frequency governor functionality 21. The active power error Perr is generated by a subtracting unit 40 of the inertia functionality 22 having the active power target PSet and the actual active power P_act as inputs. The phase angle target ¢ is generated by an integrator 41 of the inertia functionality 22 in dependence on at least a target frequency f. The target frequency f is generated by an inertia controller 42 of the inertia functionality 22. The inertia controller 42 receives the active power error Perr. The inertia controller 42 is e.g. realized as a PI controller. The inertia controller 42 e.g. includes a parameter KH/S in a forward branch and a parameter Kd in a feedback branch. Alternatively, the inertia controller 42 is realized e.g. as a PID controller or in another way.

In the frequency governor functionality 21, the setpoint frequency FSet and the actual active power P_act are provided to a first subtracting unit 43 of the frequency governor functionality 21. The actual active power P_act is modified by a frequency droop functionality 44 of the frequency governor functionality 21. The frequency error Ferr is generated by a second subtracting unit 45 of the frequency governor functionality 21 in dependence on at least the actual frequency F_act and the output of the first subtracting unit 43. The active power target PSet is generated by the frequency controller 113 in dependence on at least the frequency control error Ferr.

In the AVR functionality 23, the setpoint voltage VSet and the actual reactive power Q_act are provided to a first subtracting unit 46 of the AVR functionality 23. The actual reactive power Q_act is modified by a voltage droop functionality 47 of the AVR functionality 23. The voltage control error Verr is generated by a second subtracting unit 48 of the AVR functionality 23 in dependence on at least the actual voltage V act and the output of the first subtracting unit 46. The reactive power target Exc is generated by the voltage controller 115 in dependence on at least the voltage control error Verr.

In case the fault signal SF indicates an absence of a fault, determining the output voltage target Vd* in dependence on at least the reactive power target Exc by the rotor flux functionality 24 includes:
determining a reactive power error Qerr in dependence on at least the reactive power target Exc and an actual reactive power Q_act, and
determining the output voltage target Vd* in dependence on at least the reactive power error Qerr.

The reactive power error Qerr is provided by a subtracting unit 49 of the rotor flux functionality 24 in dependence on at least the reactive power target Exc and the actual reactive power Q_act. The rotor flux functionality 24 includes a flux controller 52 that may be named flux model controller. The flux controller 52 is e.g. realized as an integrator with the parameter Kψ or as a PI or PID controller. The flux controller 52 generates the output voltage target Vd* in dependence on at least the reactive power error Qerr.

The transformation functionality 25 includes a first and a second transformation 53, 54. The first transformation 53 receives the phase angle target Φ and the voltage target Vd* (or a quantity |Ea| derived from the voltage target Vd*) and generates a vector signal Ea. The transformation functionality 25 comprises a virtual impedance 55. A subtracting unit 56 of the transformation functionality 25 provides a further vector signal Va in dependence on at least an output of the first transformer 53 and an output of the virtual impedance 55. The second transformation 53 receives an output of the subtracting unit 56 and generates signals that are provided to the power converter 11.

In case of a fault, at least some of the following processes take place: In case the fault signal SF is set such that the fault signal SF indicates a fault, determining the phase angle target Φ in dependence on at least the active power target PSet by the inertia functionality 22 (e.g. additionally) includes either or both of the following (process 81):
adjusting at least a parameter of the inertia functionality 22 and
freezing at least an internal signal of the inertia functionality 22.

Examples of the at least a parameter of the inertia functionality 22 being adjusted are the parameter KH/S in the forward branch and the parameter Kd in the feedback branch of the inertia controller 42. Examples of the at least an internal signal of the inertia functionality 22 are the target frequency f, a signal at the output of the feedback branch with the parameter Kd or other internal signals.

In an example, in case the fault signal SF indicating a fault is detected, determining the phase angle target @ independent of the active power target PSet includes making constant the target frequency f, e.g. on a value at the time the fault signal SF indicating a fault is detected or slightly before.

While the fault signal SF indicates a fault (is active) either or both of the following actions are taken, depending on the operation of a switch arrangement 104; this ensures the output or target frequency f is frozen and hence the VSG remains synchronized to the grid 13:
the parameters of the virtual inertia model can be changed or adjusted;
the values internal to the virtual inertia model are frozen.

In case a first switch 104′ of the switch arrangement 104 is set in a conducting state, the fault signal SF is provided to a first control input 105 of the inertia controller 42 and triggers to modify at least a parameter. In case a second switch 104″ of the switch arrangement 104 is set in a conducting state, the fault signal SF is provided to a second control input 106 of the inertia controller 42 and triggers to freeze at least a value of the inertia functionality 22. In case the first switch 104′ is set in a conducting state and the second switch 104″ is set in a conducting state, the fault signal SF is provided to a first control input 105 of the inertia controller 42 and triggers to modify at least a parameter and the fault signal SF is provided to a second control input 106 of the inertia controller 42 and triggers to freeze at least a value of the inertia functionality 22.

In case the fault signal SF is set such that the fault signal SF indicates a fault, determining the output voltage target Vd* in dependence on at least the reactive power target Exc by the rotor flux functionality 24 includes either or both of the following (in a process 82):
adjusting at least a parameter of the rotor flux functionality 24 and
freezing at least a signal of the rotor flux functionality 24. The signal can be an internal signal or the output voltage target Vd*.

In an example, in case the fault signal SF indicating a fault is detected, the output voltage target Vd* is kept constant, e.g. on a value at the time the fault signal indicating a fault is detected or slightly before.

While the fault signal SF indicating a fault is detected or is active either or both of the following actions are taken, depending on the operation of a further switch arrangement 109; this ensures the output voltage target Vd* is frozen and hence the VSG remains synchronized to the grid 13:
the parameters of the flux model can be changed or adjusted;
the values internal to the flux model are frozen.

In case a first switch 109′ of the further switch arrangement 109 is set in a conducting state, the fault signal SF is provided to a first control input 110 of the flux controller 52 and triggers to modify at least a parameter. In case a second switch 109″ of the further switch arrangement 109 is set in a conducting state, the fault signal SF is provided to a second control input 111 of the flux controller 52 and triggers to freeze at least a value of the rotor flux functionality 24. In case the first switch 109′ is set in a conducting state and the second switch 109″ is set in a conducting state, the fault signal SF is provided to a first control input 110 of the flux controller 52 and triggers to modify at least a parameter and the fault signal SF is provided to a second control input 111 of the flux controller 52 and triggers to freeze at least a value of the rotor flux functionality 24.

The switch arrangement 104 and the further switch arrangement can be realized using a logic, software or transistors implementing the switches 104′, 104″, 109′, 109″.

Moreover (in a process 83), the method comprises
after changing the fault signal SF such that the fault signal SF indicates a fault, determining that the fault is no longer detected,
changing the fault signal SF such that the fault signal SF indicates an absence of a fault, and
initializing the at least one suspended functionality.

Thus, at least one of the frequency governor functionality 21 and the automatic voltage regulator 23 or both are activated from the suspended condition (which can be named unfrozen) and initialized. Initializing the at least one frozen functionality includes providing the initialization value of the at least one parameter stored in the initialization value memory 15 and/or the memory 16 to the at least one suspended functionality.

Optionally, changing the fault signal SF such that the fault signal SF indicates an absence of a fault includes waiting for a predetermined time after detecting that the fault is no longer detected before changing the fault signal SF.

The following describes examples of actions or processes that occur when a fault is cleared: The fault is no longer detected; the fault signal SF indicates an absence of a fault (in other words, the fault signal SF is lowered) at or shortly after the fault is no longer detected.
1. Upon the lowering of the fault signal SF the active power snapshot stored in the S/H memory 102 is used to initialize the frequency controller 113, by the lowering of the fault signal SF on a reset line 112; this is indicated by the falling edge trigger of the frequency controller 113;
2. Since the fault signal SF indicates an absence of a fault (fault signal SF is now inactive), the action of the frequency controller 113 is activated (e.g. unfrozen) allowing the frequency controller 113 and the frequency governor functionality 21 to operate normally. This is achieved by providing the fault signal SF indicating an absence of a fault to the freeze control input 103.
3. Since the fault signal SF now indicates an absence of a fault, both of the following actions occur:
   a. the parameters of the inertia controller 42 that realizes a virtual inertia model are restored to original values. This results from providing the fault signal SF indicating an absence of a fault to the first control input 105;
   b. the values internal to the inertia controller 42 realizing the virtual inertia model are unfrozen; this is achieved by providing the fault signal SF indicating an absence of a fault to the second control input 106.
4. Upon the lowering of the fault signal SF the reactive power snapshot stored in the further S/H memory 107 is used to initialize the AVR voltage controller 115, by the lowering of the fault signal SF on the reset line 114; this is performed at the falling edge of the fault signal SF;
5. Since the fault signal SF now indicates an absence of a fault, the action of the AVR voltage controller 115 is activated (e.g. unfrozen) allowing the voltage controller 115 and the AVR functionality 23 to operate normally; this results from providing the fault signal SF indicating an absence of a fault to the freeze control input 108.
6. Since the fault signal SF now indicates an absence of a fault, both of the following actions occur:
   a. the parameters of the flux model are restored to original values; this is achieved by providing the fault signal SF indicating an absence of a fault to the first control input 110 of the flux controller 52.
   b. the values internal to the flux controller 52 are unfrozen; this results from providing the fault signal SF indicating an absence of a fault to the second control input 111 of the flux controller 52.

After the above mentioned actions 1 through 6 have occurred the converter arrangement 10 continues to operate as per normal.

Upon the lowering of the fault signal SF, the initialization value of the actual reactive power Q_act is optionally also applied to the voltage droop functionality 47. The initialization value of actual active power P_act is optionally also applied to the frequency droop functionality 44.

While the disclosure is amenable to various modifications and alternative forms, specifics thereof have been shown by way of example in the figures and have been described in detail. It should be understood, however, that the intention is not to limit the disclosure to the particular embodiments described. On the contrary, the intention is to cover all modifications, equivalents, and alternatives falling within the scope of the disclosure defined by the appended claims.

The embodiments shown in the FIGS. 1 to 3B as stated represent exemplary embodiments of the improved converter arrangement and method of controlling; therefore, they do not constitute a complete list of all embodiments according to the improved converter arrangement and method. Actual arrangements and methods may vary from the embodiments shown in terms of arrangements, devices and signals for example.

### REFERENCE SIGNS

10 converter arrangement
11 power converter
12 control arrangement
13 grid
14 energy/load arrangement
15 initialization value memory
16 memory
21 frequency governor functionality
22 inertia functionality
23 automatic voltage regulator functionality
24 rotor flux functionality
25 transformation functionality
40 subtracting unit
41 integrator
42 inertia controller
43, 45 subtracting unit
44 frequency droop functionality
46, 48, 49 subtracting unit
47 voltage droop functionality
52 flux controller
53, 54 transformation
55 virtual impedance
56 subtracting unit
71 to 83 process
102 sample-and-hold memory
103 freeze control input
104 switch arrangement
104′, 104″ switch
105, 106 control input
107 sample-and-hold memory
108 freeze control input
112 reset input
113 frequency controller
108 control input
109 further switch arrangement
109′, 109″ switch
110, 111 control input
114 reset input
115 voltage controller
EA vector signal
Exc reactive power target
f target frequency
Ferr frequency control error
FSet setpoint frequency
F_act actual frequency
Perr active power error
PSet active power target
P_act actual active power
Qerr reactive power error
Q_act actual reactive power
SF fault signal
Va further vector signal
Vd* output voltage target
Verr voltage control error
VSet setpoint voltage
V_act actual voltage
Φ phase angle target

1. A method of controlling a power converter, wherein the method comprises:
determining a frequency control error (Ferr) in dependence on at least a setpoint frequency (FSet) and an actual frequency (F_act),
determining an active power target (PSet),
determining a phase angle target (Φ),
determining a voltage control error (Verr) in dependence on at least a setpoint voltage (VSet) and an actual voltage (V_act),
determining a reactive power target (Exc),
determining an output voltage target (Vd*), and
controlling the power converter based on the output voltage target (Vd*) and the phase angle target (Φ),
wherein the method comprises at least one of
determining the active power target (PSet) independent of the frequency control error (Ferr) in case a fault signal (SF) indicating a fault is detected and determining the active power target (PSet) in dependence on at least the frequency control error (Ferr) otherwise,
determining the phase angle target (Φ) independent of the active power target (PSet) in case a fault signal (SF) indicating a fault is detected and determining the phase angle target (Φ) in dependence on at least the active power target (PSet) otherwise,
determining the reactive power target (Exc) independent of the voltage control error (Verr) in case a fault signal (SF) indicating a fault is detected and determining the reactive power target (Exc) in dependence on at least the voltage control error (Verr) otherwise, and
determining the output voltage target (Vd*) independent of the reactive power target (Exc) in case a fault signal (SF) indicating a fault is detected and determining the output voltage target (Vd*) in dependence on at least the reactive power target (Exc) otherwise.

2. The method of claim 1, wherein the method comprises determining an initialization value of at least one of an actual active power (P_act) and an actual reactive power (Q_act) of the power converter when the fault signal (SF) indicating a fault is detected.

3. The method of claim 2,
wherein the method comprises continuously storing data in a memory in predetermined periods,
wherein the data include at least one of the actual active power (P_act) and the actual reactive power (Q_act), and
wherein determining the initialization value includes selecting the initialization value out of the data stored in the memory.

4. The method of claim 2, wherein the method comprises
determining that the fault is no longer detected, and
determining the active power target (PSet) using the initialization value of the actual active power (P_act) and/or determining the reactive power target (Exc) using the initialization value of the actual reactive power (Q_act).

5. The method of claim 4, wherein the method comprises waiting for a predetermined time after detecting that the fault is no longer detected before determining the active power target (PSet) using the initialization value of the actual active power (P_act) and/or determining the reactive power target (Exc) using the initialization value of the actual reactive power (Q_act).

6. The method of claim 1, wherein the method is configured to mimic a synchronous generator.

7. The method of claim 1, wherein, in case no fault signal (SF) indicating a fault is detected, determining the phase angle target (Ø) in dependence on at least the active power target (PSet) includes:
determining an active power error (Perr) in dependence on at least the active power target (PSet) and an actual active power (P_act), and
determining the phase angle target (Φ) in dependence on at least the active power error (Perr).

8. The method of claim 1, wherein, in case the fault signal (SF) indicating a fault is detected, determining the phase angle target (Ø) independent of the active power target (PSet) includes making constant a target frequency (f).

9. The method of claim 1, wherein, in case no fault signal (SF) indicating a fault is detected, determining the output voltage target (Vd*) in dependence on at least the reactive power target (Exc) includes:
determining a reactive power error (Qerr) in dependence on at least the reactive power target (Exc) and an actual reactive power (Q_act), and
determining the output voltage target (Vd*) in dependence on at least the reactive power error (Qerr).

10. The method of claim 1, wherein, in case a fault signal (SF) indicating a fault is detected, determining the output voltage target (Vd*) independent of the reactive power target (Exc) includes keeping the output voltage target (Vd*) constant.

11. A converter arrangement, comprising
a control arrangement and
a power converter that is realized as a voltage-controlled voltage source converter,
wherein the control arrangement is configured to execute the method of controlling the power converter of claim 1.

12. A non-transitory computer-readable medium having a computer program comprising instructions stored thereon, wherein the instructions, when executed by a processor, cause the processor to perform the method of controlling the power converter of claim 1.

13. The method of claim 3, wherein the method comprises:
determining that the fault is no longer detected, and
determining the active power target (PSet) using the initialization value of the actual active power (P_act) and/or determining the reactive power target (Exc) using the initialization value of the actual reactive power (Q_act).

14. The method of claim 13, wherein the method comprises waiting for a predetermined time after detecting that the fault is no longer detected before determining the active power target (PSet) using the initialization value of the actual active power (P_act) and/or determining the reactive power target (Exc) using the initialization value of the actual reactive power (Q_act).

15. The method of claim 4, wherein the method comprises determining the active power target (PSet) using the initialization value of the actual active power (P_act).

16. The method of claim 15, wherein the method comprises waiting for a predetermined time after detecting that the fault is no longer detected before determining the active power target (PSet) using the initialization value of the actual active power (P_act).

17. The method of claim 4, wherein the method comprises determining the reactive power target (Exc) using the initialization value of the actual reactive power (Q_act).

18. The method of claim 17, wherein the method comprises waiting for a predetermined time after detecting that the fault is no longer detected before determining the reactive power target (Exc) using the initialization value of the actual reactive power (Q_act).

19. The method of claim 1,
wherein, in case no fault signal (SF) indicating a fault is detected, determining the phase angle target (Φ) in dependence on at least the active power target (PSet) includes determining an active power error (Perr) in dependence on at least the active power target (PSet) and an actual active power (P_act), and determining the phase angle target (Φ) in dependence on at least the active power error (Perr), and
wherein, in case the fault signal (SF) indicating a fault is detected, determining the phase angle target (Φ) independent of the active power target (PSet) includes making constant a target frequency (f).

20. The method of claim 1,
wherein, in case no fault signal (SF) indicating a fault is detected, determining the output voltage target (Vd*) in dependence on at least the reactive power target (Exc) includes determining a reactive power error (Qerr) in dependence on at least the reactive power target (Exc) and an actual reactive power (Q_act), and determining the output voltage target (Vd*) in dependence on at least the reactive power error (Qerr), and
wherein, in case a fault signal (SF) indicating a fault is detected, determining the output voltage target (Vd*) independent of the reactive power target (Exc) includes keeping the output voltage target (Vd*) constant.
